(19) United States
(12) Patent Application Publication
(10) Pub. No.: US 2015/0171648 A1
(43) Pub. Date: Jun. 18, 2015

(54) CONNECTOR FOR CHARGING AN ELECTRONIC DEVICE HAVING BUILT-IN ILLUMINATION

(71) Applicant: Shawn Robert Williams, Andover, MA (US)

(72) Inventor: Shawn Robert Williams, Andover, MA (US)

(21) Appl. No.: 14/108,219

(22) Filed: Dec. 16, 2013

(51) Int. Cl. H02J 7/00; H01R 13/717

(52) U.S. Cl. CPC H02J 7/0042; H01R 13/7175

(57) ABSTRACT

A charging cord, or similar connection cable, for an electronic device provides light at one or both of its connectors. A momentarily closed switch can be incorporated into the connector so that a user can depress the switch to turn on the illumination. The switch can be conveniently located on a body portion of the connection that is normally gripped by a user during connection of the connector. This allows easy depression of the switch to turn on the light. The light can be powered by any device to which an opposite end of the cable is attached. The illuminated cord can be used for wall chargers, mobile (car) chargers, USB-connected chargers, and the like. The light can be integrated into the charger or plugged in as a separate, add-on, pass through device with male and female terminals between the existing charging tip and the electronic device.

### BACKGROUND OF THE INVENTION

The present invention relates to electronic device connectors and, more particularly, to a connector for charging an electronic device having built-in illumination.

In dark or dimly-lit environments, plugging in a battery charger into one's cell phone, tablet computer, e-reader, or other like electronic device, can be difficult. Current charger tips are not fitted with lights to illuminate the receptacle. In dark or dimly-lit environments, it is common for a user to poke at his or her electronic device to try to plug in a charging tip into the female receptacle of the electronic device. In some cases, a user can damage their charging cord plug, or, worse yet, damage their electronic device's charging port.

One current solution for a user to see the charging port and align the charging plug is to use an external light source, such as a flashlight or light fixture. These outside light sources, however, may not be available or may disturb others around the user.

As can be seen, there is a need for a charging cord having built-in illumination to illuminate the electronic device and charging cord plug when attempting the cord to the device.

### SUMMARY OF THE INVENTION

In one aspect of the present invention, a cable for connecting to an electronic device comprises a connector configured to fit into a receptacle of the electronic device; a switch disposed in a connector body from which the connector extends; and a light disposed in the connector body and configured to illuminate forward of the connector when the switch is depressed.

In another aspect of the present invention, a charging cable for an electronic device comprises a connector configured to fit into a receptacle of the electronic device, the connector extending from a connector body attached to the charging cable; a switch disposed in the connector body from which the connector extends; and a light disposed in the connector body along an edge of the connector body from which the connector extends, the light configured to illuminate forward of the connector when the switch is depressed.

In a further aspect of the present invention, a charging cable for an electronic device comprises a cable connector configured to fit into a receptacle of the electronic device; a pass through device operable to receive the cable connector, the pass through device having a connector configured to fit into the receptacle of the electronic device; a switch disposed in a connector body of the pass through device from which the connector extends; and a light disposed in the connector body along an edge of the connector body from which the connector extends, the light configured to illuminate forward of the connector when the switch is depressed.

These and other features, aspects and advantages of the present invention will become better understood with reference to the following drawings, description and claims.

### BRIEF DESCRIPTION OF THE DRAWINGS

FIG. 1 is a perspective view of an electronic device receiving a charging cable having built-in illumination according to an exemplary embodiment of the present invention;

FIG. 2 is a detailed perspective view of one embodiment of a connector on a charging cord having built-in illumination;

FIG. 3 is a detailed perspective view of another embodiment of a connector on a charging cord having built-in illumination; and

FIG. 4 is an exploded perspective view of an electronic device receiving a charging cable with an add-on illumination plug according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a charging cord, or similar connection cable, for an electronic device that provides light at one or both of its connectors. A momentarily closed switch can be incorporated into the connector so that a user can depress the switch to turn on the illumination. The switch can be conveniently located on a body portion of the connection that is normally gripped by a user during connection of the connector. This allows easy depression of the switch to turn on the light. The light can be powered by any device to which an opposite end of the cable is attached. The illuminated cord can be used for wall chargers, mobile (car) chargers, USB-connected chargers, and the like. The light can be integrated into the charger or plugged in as a separate, add-on, pass through device with male and female terminals between the existing charging tip and the electronic device.

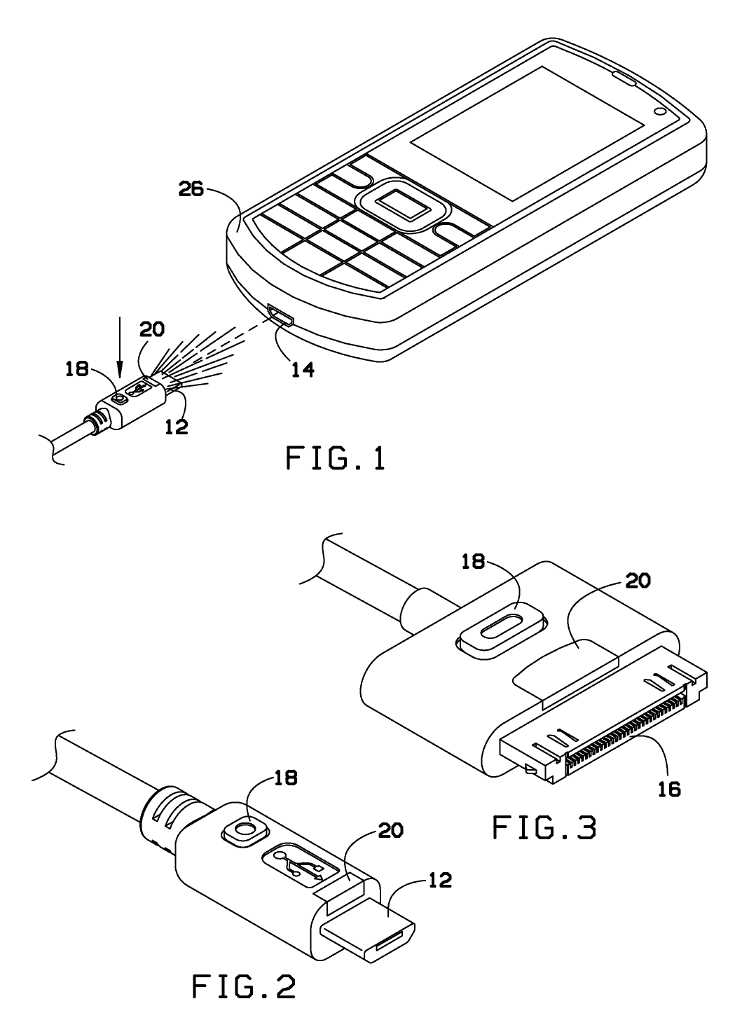

Referring now to FIGS. 1 through 3, an electronic device 26, such as a mobile phone, tablet computer, music player, e-reader, or the like, can include a receptacle 14 for receiving a connector 12. Typically, the receptacle 14 can be a charging receptacle, but other receptacles, such as data connections, headphone connections, or the like, could benefit from the present invention. The connector 12, similarly, could be a connector from a charging cable, but may be other connectors 12 for which illumination would be helpful when trying to connect the connector 12 to the electronic device 26.

The connector 12 can include a connector body 28 having a push button 18 disposed therein. The push button 18 can be a momentarily closed switch such that when the push button 18 is depressed, power is delivered to a light 20, such as one or more light emitting diodes (LEDs) and when the push button 18 is released, the switch returns to an open state, interrupting power from reaching the light 20. Typically, the push button 18 can be raised from the connector body 28 so that the push button 18 is closed easily by depressing the push button 18 to be at or near the same plane as the connector body 28.

The light 20 can be disposed at the end of the connector body 28, proximate to the connector 12, so that light emitted can shine on the receptacle 14 when the connector 12 is brought close to the receptacle 14.

As shown in FIGS. 1 and 2, the connector 12 may be a micro universal serial bus (USB) connector. As shown in FIG. 3, a connector 16 may be an IPad® or IPhone®-type connector. Of course, while two types of connectors 12, 16 are shown, the present invention may be useful for any type of connector.

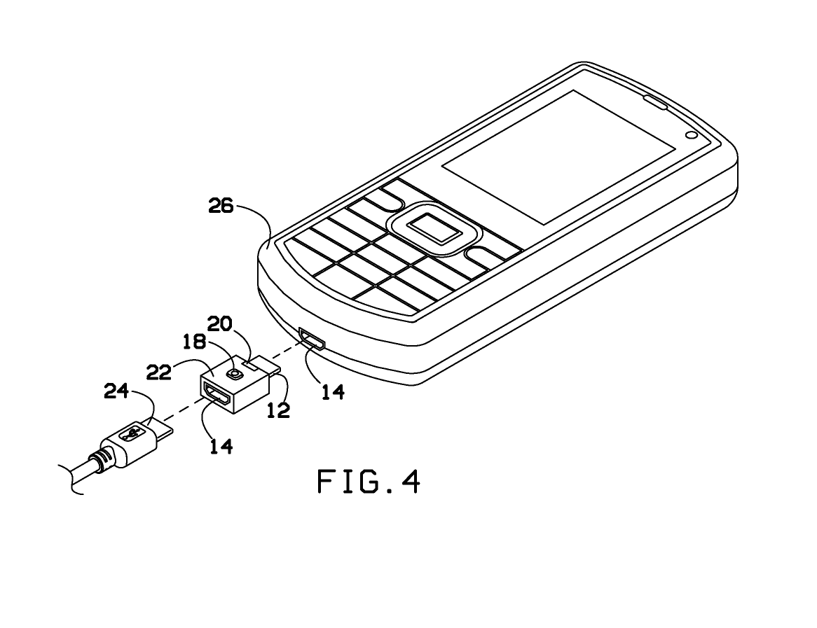

Referring now to FIG. 4, in some embodiments of the present invention, a user may use their existing connector 24 with a pass through device 22. The pass through device 22 can connect to the connector 24 and provide a connector 12 for plugging into the receptacle 14 on the electronic device 26. The pass through device 22 can include the switch 18 and the light 20, as described above, to provide connection illumination, while allowing the user to use their existing charging cable.

In some embodiments, a securing mechanism can be provided to secure the pass through device 22 to the connector 24. In this manner, the resulting connector, having the pass through device 22 secured thereto, functions nearly the same as the embodiment described above with respect to FIGS. 1 through 3, while preventing inadvertent disconnection of the pass through device 22 from the connector 24.

While the above describes using the light to provide illumination for connection the connector of a charging cable, or other similar cable, the present invention may be useful for other purposes, such as providing a light source for finding items in the car or at home, as a reading light, or the like.

It should be understood, of course, that the foregoing relates to exemplary embodiments of the invention and that modifications may be made without departing from the spirit and scope of the invention as set forth in the following claims.

What is claimed is:

1. A cable for connecting to an electronic device, comprising:
a connector configured to fit into a receptacle of the electronic device;
a switch disposed in a connector body from which the connector extends; and
a light disposed in the connector body and configured to illuminate forward of the connector when the switch is depressed.

2. The cable of claim 1, wherein the cable is a charging cable for the electronic device.

3. The cable of claim 1, wherein the light is disposed along an edge of the connector body from which the connector extends.

4. The cable of claim 2, wherein the connector is integrated with the charging cable.

5. The cable of claim 2, wherein the connector is a pass through connector operable to receive a connector terminus of the charging cable.

6. A charging cable for an electronic device, comprising:
a connector configured to fit into a receptacle of the electronic device, the connector extending from a connector body attached to the charging cable;
a switch disposed in the connector body from which the connector extends; and
a light disposed in the connector body along an edge of the connector body from which the connector extends, the light configured to illuminate forward of the connector when the switch is depressed.

7. A charging cable for an electronic device, comprising:
a cable connector configured to fit into a receptacle of the electronic device;
a pass through device operable to receive the cable connector, the pass through device having a connector configured to fit into the receptacle of the electronic device;
a switch disposed in a connector body of the pass through device from which the connector extends; and
a light disposed in the connector body along an edge of the connector body from which the connector extends, the light configured to illuminate forward of the connector when the switch is depressed.
